(19) United States
(12) Patent Application Publication
(10) Pub. No.: US 2013/0233985 A1
(43) Pub. Date: Sep. 12, 2013

(54) Hanger for Aboveground Pool Cover

(71) Applicant: James Mapes, Mayville, NY (US)

(72) Inventor: James Mapes, Mayville, NY (US)

(21) Appl. No.: 13/747,591

(22) Filed: Jan. 23, 2013

Related U.S. Application Data
(60) Provisional application No. 61/607,656, filed on Mar. 7, 2012.

(51) Int. Cl. F16M 13/02

(52) U.S. Cl. CPC F16M 13/02
USPC 248/201; 248/304; 248/205.1

(57) ABSTRACT

A plurality of adjustable hangers for storing an aboveground pool cover in an elevated position and in close proximity to an associated pool comprised of a generally U-shaped hanger portion for receipt of the pool cover, a lateral support for engaging the sidewall of the aboveground pool and a hook portion for removable attachment to the sidewall and rail or the above ground pool. In a preferred embodiment of the present invention, portions of the hanger are adjustable in size to accommodate a wide variety of aboveground pools. By storing the pool cover in an elevated position, the pool cover is not as susceptible to damage and/or damaging the surfaces upon which it would be otherwise stored, and is far less likely to transfer dirt, leaves, grass clippings, insects and other undesirable elements into the pool water when the pool cover is reinstalled on the surface of the pool.

### CROSS-REFERENCE

This application claims priority from Provisional Patent Application Ser. No. 61/607,656 filed on Mar. 7, 2012.

### FIELD OF THE INVENTION

This invention relates to an improved hanger for an above ground pool cover that permits the pool cover to be stored in an elevated position and adjacent to the aboveground pool when not in use. The improved hanger is adjustable and does not require tools for assembly or adjustment. The improved hanger is also relatively easy to install and use, inexpensive to manufacture and can accommodate a wide variety of shapes and sizes of pool covers and pool rails.

### BACKGROUND

Many individuals with aboveground pools cover the surface of the pool water with a pool cover or solar blanket when the pool is not in use to keep debris, such as leaves, grass clippings, insects and the like from entering the pool. Pool covers, such as solar pool covers, are also useful in heating and/or maintaining the temperature of the pool water when the pool is not being used. The forgoing are but a few of the many advantages known in the art that are associated with pool covers and solar blankets.

Despite the many advantages of aboveground pool covers and solar blankets, it can be challenging to store said covers and blankets when the same are not in use. For example, most pool owners desiring access to their aboveground pool will simply pull or roll the cover off of the pool and place the same on the ground or the deck of the pool. However, such storage techniques often result in the cover becoming dirty with debris such as dirt, grass clippings, leaves, insects and the like, which may then be inadvertently deposited into the pool water when the cover is re-installed onto the pool. The introduction of such debris into the pool water not only degrades the quality and aesthetics of the pool water, but can also damage pool pumps, filters and other pool equipment. Once such debris enters the pool water, the pool owner will typically be required to clean the pool and/or add chemicals to treat the pool water, both of which can be time consuming and expensive and are therefore undesirable.

Another common problem associated with storing an unused pool cover or solar blanket on the ground or pool deck is that the cover can become damaged or torn by people or pets stepping on the same, or the cover being pulled across a rough surface such as a rock, nail, splintered wood, etc. Not only can the cover become damaged by storing the same on the ground or pool deck, but the pool cover or solar blanket may also cause damage to the surface upon which it is being stored. For example, pool water, which typically contains harmful chemicals, may be transferred from the pool by the pool cover to the ground or pool deck. Said chemicals can kill grass, plants and other vegetation, and/or stain the surface of the pool deck over time. Solar pool covers that are stored on grassy surfaces have also been known to burn the grass beneath the cover, particularly on sunny days.

Pool covers and solar blankets can also be heavy, particularly when wet, and difficult and/or awkward to carry because of their shape and size. Because it may be difficult for the pool owner to transport the heavy and awkward cover over relatively long distances to store the same when not in use, it is also desirable to have a pool cover holder that is located in close proximity to the associated pool.

Consequently, there exists in the art a long-felt need for an improved aboveground pool cover hanger that can be removably attached to an aboveground pool for easy and convenient storage of an associated pool cover. There also exists in the art a long felt need for an improved pool cover hanger that is adjustable and can accommodate a wide variety of shapes and sizes of pool covers and/or solar blankets, as well as aboveground pools. Moreover, there is a long felt need for an aboveground pool hanger that does not require any tools to assemble and/or adjust the hanger. Finally, there is a long-felt need for an aboveground pool cover hanger that accomplishes all of the forgoing objectives and that is relatively inexpensive to manufacture, aesthetically pleasing, and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof; is a plurality of improved hangers for supporting and storing an aboveground pool cover and/or solar blanket when not in use, and in close proximity to the associated aboveground pool. Each of the plurality of improved pool cover hangers can be removably attached and positioned along the sidewall of an aboveground pool and is preferably comprised of a generally U-shaped cradle portion, a lateral support for engaging the sidewall of the aboveground pool and a hook portion for removable and repositionable attachment to the sidewall and rail of an aboveground pool. In a preferred embodiment of the present invention, the hook portion and lateral support are both adjustable in size to accommodate a wide variety of aboveground pools.

The plurality of improved pool cover hangers allows an individual to safely and securely store their aboveground pool cover and/or solar blanket off of the ground and in close proximity to the associated pool when not in use. By storing the pool cover in an elevated position, the pool cover is not as susceptible to damage and/or damaging the surfaces upon which it would otherwise be stored, and is far less likely to transfer dirt, leaves, grass clippings, insects and other undesirable elements into the pool water when the pool cover is reinstalled on the surface of the pool. Moreover, tools are not required to install or adjust the aboveground pool solar cover hanger of the present invention. Finally, the aboveground pool cover hanger of the present invention accomplishes all of the forgoing objectives and is relatively inexpensive to manufacture, aesthetically pleasing, and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a preferred embodiment of the aboveground pool cover hanger of the present invention.

FIG. 2 illustrates a perspective view of a plurality of the hangers depicted in FIG. 1 installed on the sidewall of an aboveground swimming pool with a solar cover thereon.

FIG. 3 illustrates a close-up perspective view of one of the hangers depicted in FIG. 2 installed on the sidewall of an aboveground swimming pool with a solar cover thereon.

FIG. 4 is a perspective exploded view of the components of one embodiment of the hanger of the present invention.

FIG. 5 illustrates a perspective view of a plurality of the hangers depicted in FIG. 1 installed on the sidewall of an aboveground swimming pool, and supporting a solar cover.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

The plurality of improved aboveground pool cover hangers permit an individual to store an unused aboveground pool cover in an elevated position and in close proximity to the associated swimming pool. By storing the pool cover in an elevated position, the pool cover is not as susceptible to damage and/or damaging the surfaces upon which it would otherwise be stored, and is far less likely to transfer dirt, leaves, grass clippings, insects and other undesirable elements into the pool water when the pool cover is reinstalled on the surface of the pool. Finally, the aboveground pool cover hanger of the present invention accomplishes all of the forgoing objectives and is relatively inexpensive to manufacture, aesthetically pleasing, and safe and easy to use.

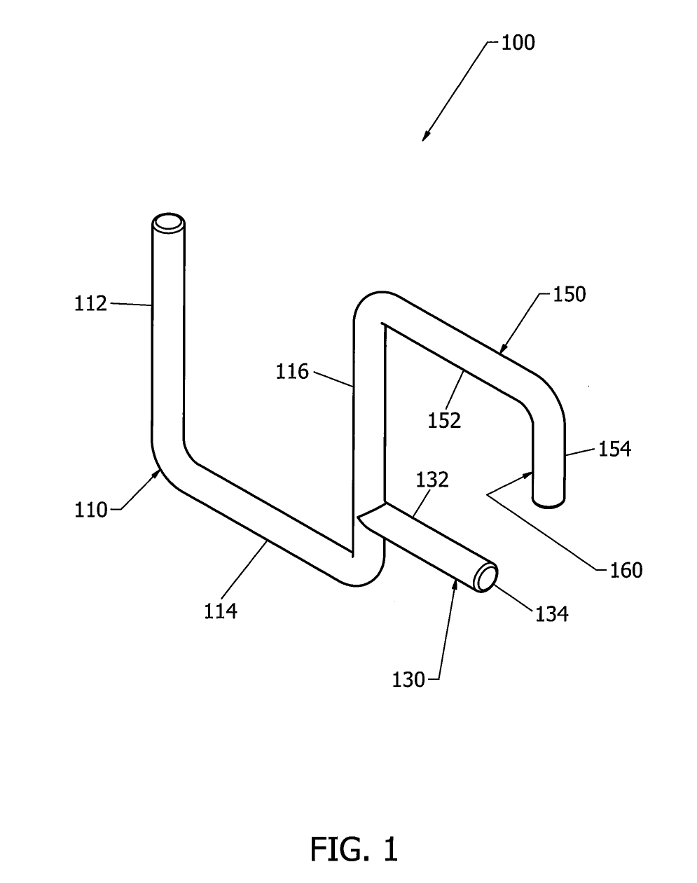

Referring initially to the drawings, FIG. 1 illustrates a perspective view of a preferred embodiment of an improved hanger device 100 of the present invention. Hanger device 100 is preferably comprised of a cradle portion 110 for receipt of a pool cover, a lateral support 130, and a hook portion 150 for removably attaching hanger 100 to the rail and sidewall of an aboveground pool, as described more fully below. Hanger 100 can be manufactured of unitary construction or comprised of individual components, such as sections of pipe, attached to one another by any common means known in the art. Unless otherwise specified herein, hanger device 100 is preferably comprised of plastic, fiberglass, metal, polyvinyl chloride, or any other sturdy material that is generally weather resistant and capable of supporting the load of a pool cover.

In a preferred embodiment of the present invention, cradle portion 110 is generally U-shaped and comprised of a first leg 112, a connector 114 and a second leg 116, though it is contemplated that other shapes could also be used without affecting the overall concept of the present invention, provided that the same are capable of retaining a pool cover in the manner described herein. First leg 112 is an elongated member that is in a generally parallel, spaced apart relationship with and connected to second leg 116 by connector 114. The distance between first and second legs 112, 116 is preferably between 6 and 14 inches to accommodate the width of most rolled or folded pool covers. Likewise, the overall depth of cradle portion 110, as measured from the end of first leg 112 to connector 114, is preferably between 9 and 14 inches. Nonetheless, it is contemplated that other widths and depths could also be employed to satisfy a particular application or suit user preference.

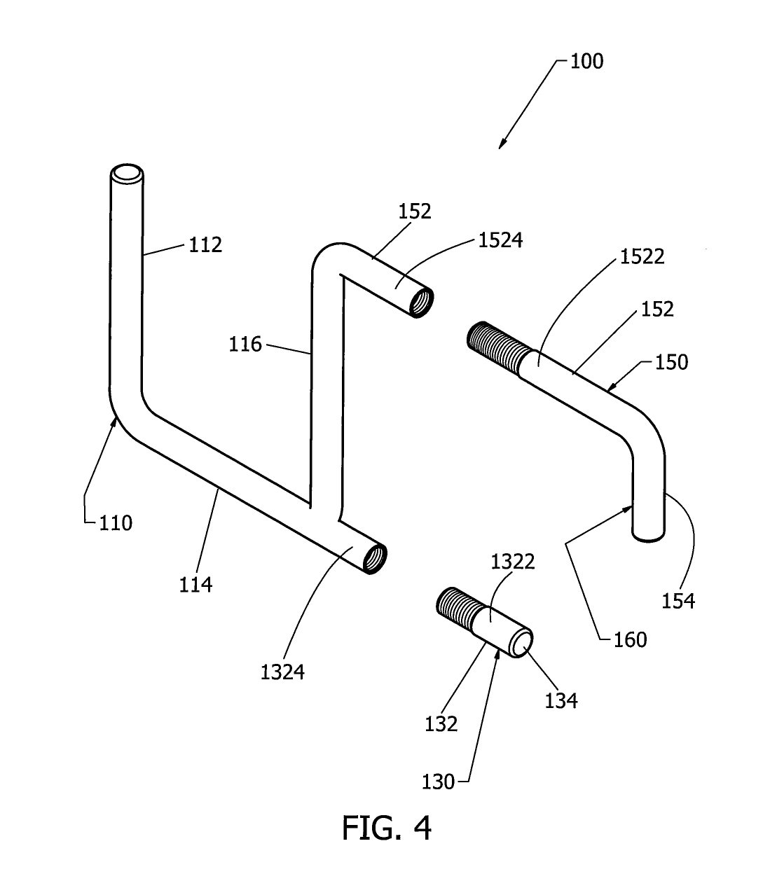

As illustrated in FIGS. 1 and 4, lateral support 130 is comprised of an elongated body member 132 that extends outwardly from cradle portion 110 and in the general direction of the pool sidewall, and an end portion 134 for contacting said pool sidewall. The overall length of lateral support 130, as measured from cradle portion 110 to end portion 134, is preferably between 5 and 10 inches, but can be varied to suit the needs of the user. As explained below, the overall length of lateral support 130 can also be adjustable.

The purpose of lateral support 130 is to transfer a portion of the load or weight of hanger device 100 and the pool cover that rests in cradle portion 110 against the sidewall of the pool, and to prevent or reduce the likelihood that device 100 will prematurely detach from the pool rail. As illustrated in FIG. 1, in one embodiment of the present invention, lateral support 130 extends outwardly from the second leg 116 of cradle portion 100 at an elevation above that of connector 114. Nonetheless, as shown in FIG. 4, it is also contemplated that lateral support 130 could extend outwardly from and at the same elevation as cradle portion 100. End portion 134 is preferably blunt in shape so as to not puncture or otherwise damage the pool sidewall and may further comprise a non-slip surface such as rubber, plastic or the like.

Hook portion 150 is preferably generally L-shaped and comprised of a first member 152 that extends outwardly from second leg 116 in the general direction of the pool, and a second member 154 that extends generally downward from the end of first member 152 opposite second leg 116. As best illustrated in FIG. 1, second leg 116, first member 152 and second member 154 form an opening 160 in hanger device 100 for receipt of a pool rail as described further below. The overall length of opening 160, as measured from second leg 116 to second member 154 is preferably between 6 and 12 inches to accommodate the width of most pool rails though other dimensions can also be used to accommodate a particular user's needs.

In a preferred embodiment of the present invention, which is depicted in FIG. 4, first member 152 can be further comprised of two separate portions, namely a threaded male portion 1522 and a corresponding threaded female portion 1524 for receipt of said threaded male portion 1522. It should be appreciated that by screwing/unscrewing male portion 1522 into/out of female portion 1524, a user can shorten or lengthen the overall length of first member 152 and correspondingly decrease or increase the size of opening 160 to accommodate pool rails of various shapes and sizes. Of course, the use of threaded male portion 1522 and threaded female portion 1524 is just one way of increasing/decreasing the size of opening 160, and other means are known in the art. For example, a telescoping first member can also be used to adjust the overall length of opening 160 without affecting the overall scope of the present invention.

As also depicted in FIG. 4, body member 132 of lateral support 130 can be further comprised of two separate portions, namely a threaded male portion 1322 and a corresponding threaded female portion 1324 for receipt of said threaded male portion 1322. It should be appreciated that by screwing/unscrewing male portion 1322 into/out of female portion 1324, a user can shorten or lengthen the overall length of lateral support 130 to establish contact with pool sidewall 212. Of course, the use of threaded male portion 1322 and threaded female portion 1324 is just one way of adjusting the overall length of lateral support 130, and other means are known in the art. For example, a telescoping lateral support 130 could also be used without affecting the overall scope of the present invention.

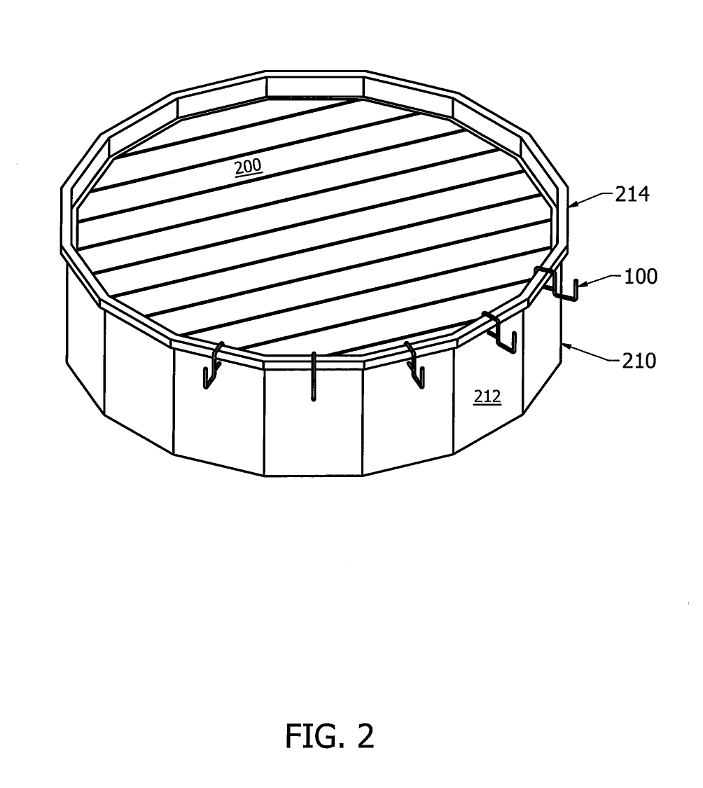

Having now described the overall structure of hanger device 100, its use and usefulness will now be described. FIG. 2 illustrates a perspective view of a pool cover 200 installed on an aboveground pool 210, which is comprised of a sidewall 212 and a pool rail 214 positioned atop of said sidewall 212. FIG. 2 also illustrates a plurality of hanger devices 100 positioned along said sidewall 212 and pool rail 214. A user (not shown) desiring to remove said pool cover 200 from pool 210 and store the cover 200 adjacent to said pool 210 in hanger devices 100 will simply roll-up the cover 200 or fold it accordion style and slip the same over rail 214 and into cradle portion 110 of hanger device 100. In this manner, cover 210 does not come into contact with the ground or other rough or dirty surface, thereby greatly reducing the likelihood that cover 200 will become damaged or transfer debris, such as leaves, grass clippings, insects and the like into the pool 210. Further, because hanger devices 100 are located immediately adjacent to sidewalls 212, the user does not have to transport cover 200, which can be heavy and awkward to carry, over a long distance to store the same.

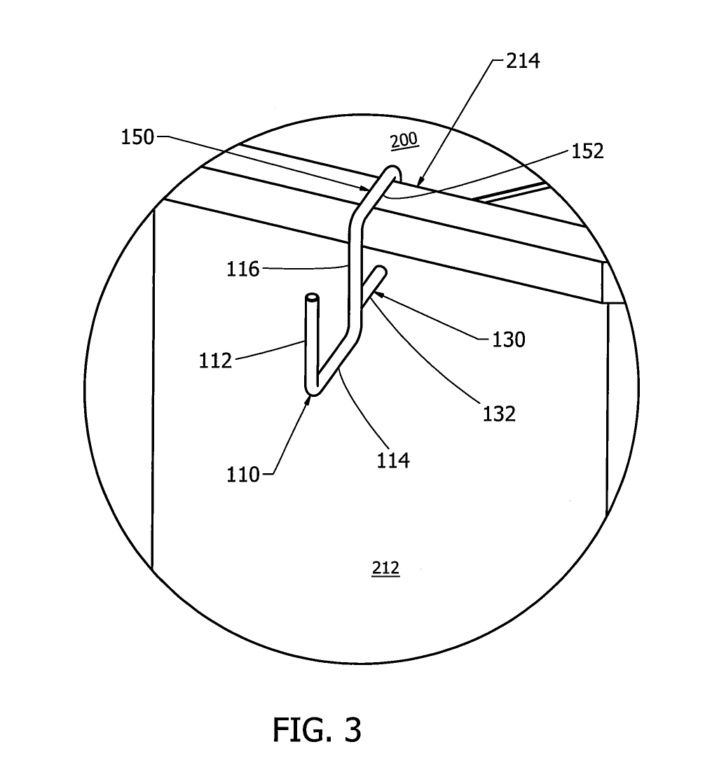

To install hanger 100 on pool 210, a user (not shown) will simply slip pool rail 214 into opening 160 of hanger device 100 as best shown in FIG. 3. When correctly installed, end portion 134 of lateral support 130 will be in contact with pool sidewall 212 and transfer a portion of the load associated with hanger 100 and the pool cover 200 to pool sidewall 212. As previously stated, in a preferred embodiment of the present invention, the overall length of first member 152 of hook portion is adjustable in size to enable hanger device 100 to accommodate a wide variety of shapes and sizes of pool rail 214.

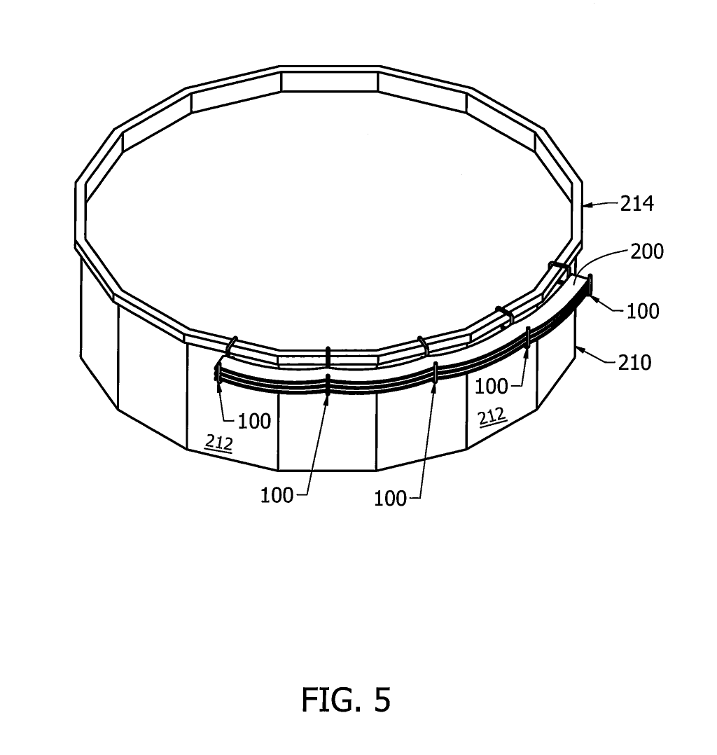

FIG. 5 illustrates a perspective view of a plurality of hanger devices 100 attached to the sidewall 212 and rail 214 of an aboveground pool 210, and supporting a pool cover 200 in an elevated position adjacent to sidewall 212. To reinstall cover 200 on pool 210, a user (not shown) will simply pull the folded or rolled up cover 200 back over rail 214 and onto the surface of the pool 210. Because the cover 200 is immediately adjacent to pool 210, the user does not need to transport cover 200, which may be heavy and awkward to carry, over a long distance to reinstall the same on the surface of pool 210. Similarly, because cover 200 does not come into contact with the ground or other rough or unclean surfaces, the likelihood of cover 200 becoming damaged or transporting debris, such as leaves, grass clippings, insects and the like into the pool 210 is eliminated or greatly reduced.

Consequently, the improved pool cover hanger device of the present invention enables a user to easily store a pool cover in close proximity to an aboveground pool and in an elevated position where the cover is less susceptible to damage and/or debris. Due to its adjustability, the improved pool cover hanger device of the present invention can accommodate a wide variety of shapes and sizes of pool covers and/or solar blankets, as well as aboveground pools. Additionally, the improved pool cover hanger device of the present invention is relatively inexpensive to manufacture, aesthetically pleasing, and safe and easy to use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hanger for an aboveground pool cover comprising:
a cradle portion;
a lateral support; and
a hook portion.

2. The hanger of claim 1, wherein said hook portion further comprises a first member that is adjustable in length.

3. The hanger of claim 2, wherein said first member further comprises a male portion and a female portion.

4. The hanger of claim 1 wherein said lateral support is adjustable in length.

5. The hanger of claim 1 wherein said cradle portion is comprised of a first leg, a connector and a second leg.

6. The hanger of claim 1 wherein said hanger is of unitary construction.

7. The hanger of claim 1 wherein said hanger is comprised of a material selected from a group consisting of plastic, fiberglass, metal and wood.

8. A device for storing a pool cover comprising:
a plurality of hangers, wherein each of said plurality of hangers further comprises
a cradle portion;
a lateral support; and
a hook portion; and
wherein said pool cover is stored in the cradle portion of each of said plurality of hangers adjacent to a sidewall of an aboveground pool.

9. The device of claim 8, wherein said hook portion further comprises a first member that is adjustable in length and wherein said lateral support is also adjustable in length.

10. The device of claim 9, wherein said first member further comprises a male portion and a female portion.

11. The device of claim 10 wherein a portion of said male portion is threaded.

12. The device of claim 8 wherein said cradle portion is comprised of a first leg, a connector and a second leg.

13. The device of claim 8 wherein said hanger is of unitary construction.

14. The device of claim 8 wherein said hanger is comprised of a material selected from a group consisting of plastic, fiberglass, metal and wood.

15. A device for storing a pool cover comprising:
at least one hanger, wherein said at least one hanger further comprises
a cradle portion;
a lateral support; and
a hook portion; and
wherein said pool cover is stored in the cradle portion of said at least one hanger adjacent to a sidewall of an aboveground pool and in an elevated position.

16. The device of claim 15, wherein said hook portion further comprises a first member that is adjustable in length.

17. The device of claim 16, wherein said first member further comprises a male portion and a female portion.

18. The device of claim 17 wherein a portion of said male portion is threaded.

19. The device of claim 15 wherein said at least one hanger is of unitary construction.

20. The device of claim 15 wherein said hanger is comprised of a material selected from a group consisting of plastic, fiberglass, metal and wood.
